(19) United States
(12) Patent Application Publication
(10) Pub. No.: US 2026/0343163 A1
(43) Pub. Date: Oct. 29, 2026

(54) Systems and Methods for Simulating Realistic Sound in a Splat-Generated Three-Dimensional Environment

(71) Applicant: Illuscio, Inc., Culver City, CA (US)

(72) Inventor: Pedro Alfonso, Liberty Hill, TX (US)

(73) Assignee: Illuscio, Inc., Culver City, CA (US)

(21) Appl. No.: 19/188,366

(22) Filed: Apr. 24, 2025

(51) Int. Cl. H04S 7/00

(52) U.S. Cl. CPC H04S 7/301; H04S 7/303

(57) ABSTRACT

An audio engine is disclosed for dynamically and in real-time adjusting sound from a sound source before the sound reaches a listening positioning in a splat-generated three-dimensional (3D) environment. The audio engine projects sound rays from the sound source to simulate sound wave propagation in the 3D environment. The audio engine tracks the sound ray paths as the sound rays contact and reflect off different surfaces formed from different sets of splats. The audio engine selects a subset of sound rays that reach the listening position. The audio engine adjusts the sound associated with each selected sound ray based on acoustic characteristics of splats that are layered over one another at a threshold number of layers of a surface contacted by the selected sound ray, and plays a modified sound at the listening position based on the adjusted sounds of the selected sound rays.

### BACKGROUND

Realistically simulating sound in a three-dimensional (3D) environment involves accounting for the positioning, shape, and acoustic characteristics of different 3D objects within the 3D environment and/or how the positioning, shape, and acoustic characteristics of the 3D objects affect sound traveling from a sound source to a listening position. The 3D objects may block, distort, interfere, or otherwise adjust the sound that originates from the sound source before it reaches the listening position. Accordingly, the sound heard at the listening position may differ from the sound originated by the sound source due to echoes, reflections, reverberations, attenuations, and/or other sound effects the 3D objects impart on the sound as it travels from the sound source to the listening position.

Spatial audio engines, application programming interfaces (APIs), and/or other systems have been developed to simulate the effects that 3D objects defined with connected sets of meshes or polygons have on sound. However, these systems, their sound algorithms, and/or their techniques for adjusting sound are incompatible with splats and splat-generated 3D environments.

Splats, including Gaussian splats, are different 3D primitives than meshes, polygons, points, and/or other primitives used to generate 3D mesh models or point clouds. Splats are layered translucent or semi-transparent ellipsoidal primitives that blend together to generate surfaces for a 3D model or 3D environment. Accordingly, new audio engines and techniques are needed to simulate realistic sound including echoes, reflections, reverberations, attenuations, and/or other sound effects that 3D objects generated with layered splats impart on sound.

### BRIEF DESCRIPTION OF THE DRAWINGS

FIG. 1 illustrates an example of generating real-time realistic sound in a splat-generated three-dimensional (3D) environment in accordance with some embodiments presented herein.

FIG. 2 illustrates an example of optimizing the sound adjustment by using sound rays to represent the sound waves originating from a sound source in accordance with some embodiments presented herein.

FIG. 3 illustrates an example of preprocessing splats for optimized real-time sound adjustment in accordance with some embodiments presented herein.

FIG. 4 illustrates an example of preprocessing the splats for optimized real-time sound adjustment based on existing attributes of the splats in accordance with some embodiments presented herein.

FIG. 5 illustrates an example of preprocessing or optimizing a splat-generated 3D environment for real-time sound adjustment using tiles in accordance with some embodiments presented herein.

FIG. 6 presents a process for performing the real-time sound adjustment in a splat-generated 3D environment in accordance with some embodiments presented herein.

FIG. 7 illustrates example components of one or more devices, according to one or more embodiments described herein.

### DETAILED DESCRIPTION OF PREFERRED EMBODIMENTS

The following detailed description refers to the accompanying drawings. The same reference numbers in different drawings may identify the same or similar elements.

Provided are systems and associated methods for simulating realistic sound in a splat-generated three-dimensional (3D) environment. The systems and methods include a splat audio engine that dynamically and in real-time adjusts sound from a sound source before the sound reaches a listening positioning in a splat-generated 3D environment based on acoustic characteristics of splats in the sound path. The splat audio engine may reference the acoustic characteristics of the splats in the sound path to model or simulate echoes, reflections, reverberations, attenuations, and/or other sound effects that different materials represented by the splats in the sound path impart on the traveling sound wave.

Gaussian splats and other splat primitives (i.e., splats) generate seemingly solid surfaces in a splat-generated 3D environment from a blended rendering of multiple layers of semi-transparent splats. The splats act like layers of molecules that collectively form a surface that sound partially penetrates before being reflected. Each splat layer may adjust the sound differently or by a different amount. The splat audio engine accounts for the acoustic characteristics of the different splat layers when dynamically and in real-time adjusting the sound that is emitted from a sound source and reflects off the different splat layers before arriving at a listening position in the splat-generated 3D environment where the adjusted sound is heard or played back. 3D mesh models and point clouds differ in that only a single layer of meshes or points may be used to generate a surface such the acoustic characteristics of the surface are fully represented by that single layer of meshes or points.

However, the splat audio engine does not adjust sound based on the acoustic characteristics of every splat at every depth layer that any part of a sound wave contacts. Doing so would be computationally expensive, may result in inaccurate sound effects, and may delay the playback of the adjusted sound relative to the rendered visualizations of the splat-generated 3D environment. For instance, the start and end of each surface in the splat-generated 3D environment is indeterminate and unrealistic sound would be generated if the sound passes through layers of splats that represent different surfaces and the acoustic characteristics of the different surfaces are used to adjust the sound. Similarly, if the sound is reflected at an incorrect depth in a layered set of splats, the sound may be incorrectly or inaccurately adjusted based on an incomplete set of acoustic characteristics.

The splat audio engine implements various optimizations to preserve the accuracy of the adjusted sound and to ensure that the adjusted sound is generated and played back in real-time at the listening position to match the rendered visualizations of the splat-generated 3D environment. In some embodiments, the splat audio engine optimizations include limiting the number of splat layers within a represented surface that affect the sound. For instance, the splat audio engine may preprocess the splats by tagging splats that represent the specific layer or the last layer of a surface that affects the sound and/or the layer at which the sound is reflected back into the splat-generated 3D environment. Alternatively, the splat audio engine may group layers of splats as tiles and base the sound adjustment off the acoustic characteristics that each tile inherits from a grouped layering of splats. In some embodiments, the splat audio engine optimizations include limiting the number of times that sound is reflected and adjusted by different surfaces or layers of splats representing the different surfaces before the adjusted sound is played at the listening position. In some embodiments, the splat audio engine optimizations include restricting the arc or size of the sound wave that is distributed and/or adjusted from the sound source through the splat-generated 3D environment.

The various optimizations eliminate unnecessary calculations or sound adjustments from splats that do not contribute to the adjusted sound heard at the listening position. This includes splats at layers that the sound does not reach and/or splats of different surfaces stacked atop one another. The various optimizations also prevent inconsequential or infinite reflecting of sound in the splat-generated 3D environment and eliminate adjustments that may be made after the sound becomes inaudible due to attenuation or dampening from prior contacted surfaces or layers of splats.

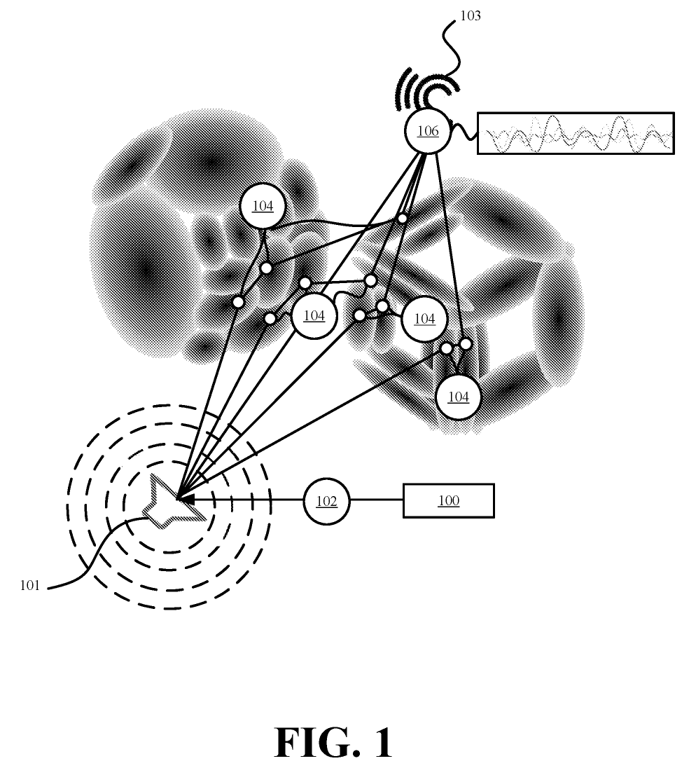

FIG. 1 illustrates an example of generating real-time realistic sound in a splat-generated 3D environment in accordance with some embodiments presented herein. In some embodiments, the splats for the splat-generated 3D environment are generated by a neural network. The neural network layers semi-transparent splats to create a photorealistic representation of a 3D environment. The neural network may generate the splat representation from two-dimensional (2D) images that capture the 3D environment from different angles or perspectives or from primitives of another 3D format (e.g., a mesh or point cloud representation of the 3D environment).

The splats may include different shaped and sized ellipsoids that are defined with a position, size, orientation, and color properties. More specifically, each splat may be defined with a position in a 3D space, a covariance matrix that specifies how the ellipsoid is stretched or scaled, an alpha property for the splat transparency, and spherical harmonics to model the view-dependent appearance (e.g., coloring) of the splat.

In some embodiments, the splats may be defined with acoustic characteristics. The acoustic characteristics of a splat may specify how that splat adjusts sound that contacts, penetrates, or reflects off that splat. For instance, the acoustic characteristics may specify an amount of echo, reflection, reverberation, and/or attenuation that the splat imparts to the sound, how the splat affects the sound volume or modifies certain frequencies (e.g., with echo, reflection, reverberation, attenuation, etc.), and/or how the splat changes pitch, tone, and/or other sound properties.

In some other embodiments, the splats are defined with a material property (e.g., wood, plastic, ceramic, rigid, hollow, etc.). Different material property values may be associated with different acoustic characteristics that mimic the real world acoustic characteristics of those real world material properties.

In still some other embodiments, the acoustic characteristics are defined from one or more existing attributes of the splats. In some such embodiments, the shape and transparency of the splat may be converted to different acoustic characteristics. For instance, a flat splat that is perpendicular to the sound wave may attenuate and/or adjust the sound by a greater amount than a rounded splat with a diameter and/or that is offset from the direction of the sound wave.

Splat audio engine 100 adjusts sound within the splat-generated 3D environment to realistically simulate and/or recreate the effects that the surfaces represented by the splats have on sound propagating in the 3D environment. The sound is generated from sound source 101 and the sound as adjusted by splat audio engine 100 is played back at listening position 103.

Sound source 101 may be linked or associated with a set of splats that represent a character, object, or sound producing element in the 3D environment. The 3D environment may have many different sound sources 101 that each generate different sounds at different times.

In some embodiments, listening position 103 may be linked or associated with another set of splats that represent a different character, object, or sound hearing element in the 3D environment. In some other embodiments, listening position 103 is associated with the position at which the 3D environment is rendered or the position of a virtual camera within the 3D space of the 3D environment.

Splat audio engine 100 optimizes the sound adjustment by restricting (at 102) the sound wave that is emitted from sound source 101. Sound waves are longitudinal waves that normally travel in all directions from the sound source as an expanding sphere of sound. To reduce the computational effort while maintaining sound accuracy, splat audio engine 100 models the sound from sound source 101 as rays or vectors that are emitted at different angles to represent the full propagation of the sound. Splat audio engine 100 identifies the rays that arrive first at listening position 103. These rays represent the sound waves that are attenuated the least by virtue of propagating in the direction of listening position 103, that are affected by the fewest splats, obstructions, and/or reflections, and therefore represent the majority of the sound heard at listening position 103. Other later arriving sound rays may be less audible as a result of greater attenuation from reflecting off more splats, obstructions, and/or reflections, and may be omitted from being played back sound at listening position 103 without losing the sound accuracy as the later arriving sound rays may be inaudible or are drowned out by the lesser attenuated sound rays.

Splat audio engine 100 adjusts (at 104) the selected or restricted (at 102) sound rays based on the acoustic characteristics of the splats that form or represent a surface in the path of those sound rays. Splat audio engine 100 limits the sound adjustments (at 104) made at each contacted surface by allowing the sound rays to penetrate and be affected by the acoustic properties of up to a threshold number of splats. For instance, a surface that is contacted by a sound ray may be generated by seven layered splats. Splat audio engine 100 adjusts the sound ray based on the acoustic characteristics associated with the first five layered splats. Another surface that is contacted by a sound ray may be generated by two layered splats which is less than the threshold number of splats. In this case, splat audio engine 100 determines that the surface is formed with less than the threshold number of splats and adjusts the sound ray based on the acoustic characteristics associated with the two splats. Splat audio engine 100 reflects the adjusted sound ray off a contacted surface according to a surface normal that is associated with that contacted surface. In some embodiments, the surface normal of the contacted surface may be defined as the surface normal of the last splat or the lowest-depth splat from the contacted surface or may be determined from the angle or orientation of the last splat or the lowest-depth splat. In some other embodiments, the surface normal of the contacted surface may be defined from the surface normals, angles, or orientations of all splats of the contacted surface that were used in adjusting the sound.

Splat audio engine 100 continues adjusting (at 104) the selected sound rays until the adjusted sound rays arrive at listening position 103. Splat audio engine 100 plays (at 106) the adjusted sound of the adjusted sound rays in response to determining that the adjusted sound rays have reached listening position 103. In some embodiments, splat audio engine 100 combines or merges the adjusted sound from each of selected sound rays to generate a single composite audio stream for the effects that the acoustic characteristics of the splats in the splat-generated 3D environment have on the sound propagating from sound source 101 to listening position 103.

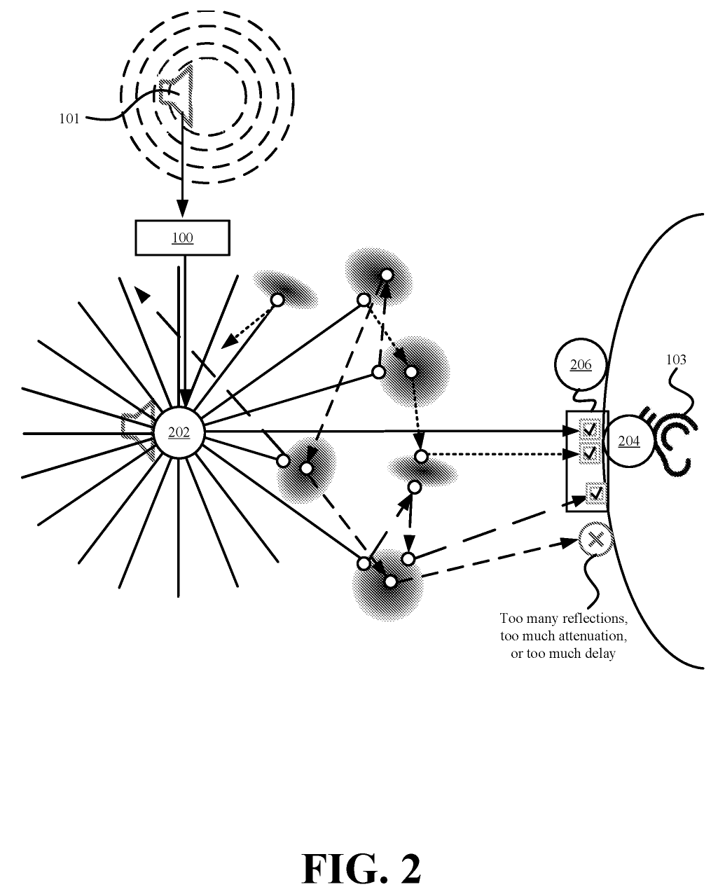

FIG. 2 illustrates an example of optimizing the sound adjustment by using sound rays to represent the sound waves originating from sound source 101 in accordance with some embodiments presented herein. In the physical world, sound is a propagating wave that expands in all directions. However, treating sound as a wave may be too computationally expensive in a splat-generated 3D environment because of the exponentially increasing computations associated with any part of the expanding wave contacting any splat and each contacted splat reflecting the sound as a new expanding sound wave. For instance, the expanding sound wave may contact several hundreds or thousands of splats with each contacted splat being associated with a calculation for adjusting some part of the sound wave based on the unique acoustic characteristics associated with that splat. Each contacted splat reflects the adjusted sound wave as another expanding wave in the 3D environment that may again contact hundreds or thousands of splats. Accordingly, splat audio engine 100 models the sound propagation as a set of rays instead of a continuous wave. Splat audio engine 100 projects (at 202) each ray from sound source 101 at a different angle to simulate the expansion of the sound wave with discrete vectors. The number of rays projected (at 202) from sound source 101 may vary based on the computational resources of the device that executes splat audio engine 100, the number of distinct sound sources, and/or the complexity of the splat-generated 3D environment. For instance, splat audio engine 100 may reduce the number of rays that are projected (at 202) in response to high resource usage due to the 3D environment having several sound sources to process in real-time and a large number of splats to render, and may increase the number of rays that are projected (at 202) in response to low resource usage due the 3D environment having a single sound source to process in real-time and a small number of splats to render.

Splat audio engine 100 tracks (at 204) the path of each ray as the rays make contact or intersect with the position of different splats and reflect off those splats until ultimately arriving at listening position 103 or moving outside the 3D environment. To reduce the calculations associated with tracking (at 204) the ray path, each ray is reflected after contact with a splat as a ray rather than a wave. The ray is reflected according to the orientation and/or surface normal of the contacted splat.

In some embodiments, splat audio engine 100 tracks (at 204) the path of each ray until a first ray or a specified number of rays reach listening position 103. For instance, adjusted sound from sound source 101 may be accurately simulated based on the adjustments made to the first arriving ten rays at listening position 103 other rays that arrive later due to additional reflections within the 3D environment may be attenuated or dampened to the point that their sound contribution is inaudible or inconsequential. In some other embodiments, splat audio engine 100 may halt the tracking (at 204) of a ray once that ray is reflected off a certain number of splats or represented surfaces and has yet to reach listening position 103.

Splat audio engine 100 selects (at 206) a subset of the sound rays for computing the adjustments that the splat-generated 3D environment has on the sound from sound source 101 based on the tracked (at 204) paths. The subset of the sound rays may include a maximum number of rays that arrive at listening position 103 with the fewest reflections or obstructions from contacted splats, with the least total distance traveled in the 3D environment, and/or with the least attenuation.

Splat audio engine 100 generates the adjusted sound at listening position 103 based on the adjustments made to the selected (at 206) subset of the sound rays. In some embodiments, splat audio engine 100 combines the adjusted sound from each ray of the subset of sound rays that reaches listening position 103. In some such embodiments, combining the adjusted sound may include averaging the adjusted sound properties of each ray to produce the final adjusted sound. In some other such embodiments, combining the adjusted sound may include combining different adjusted sound properties from different sound rays to generate the final adjusted sound. For instance, splat audio engine 100 may combine the attenuation amount from the sound ray that is adjusted with the greatest amount of attenuation, with the reverberation amount from the sound ray that is adjusted with the greatest amount of attenuation, and with the changes to pitch from the sound ray that has the pitch adjusted by the greatest amount.

Generally, individual splats do not represent solid surfaces or solid parts of a surface. Instead, multiple layers of splats are blended together to represent one solid surface. For instance, a first surface may be represented by blending together three layers of splats (e.g., splats at different depths) while a second surface may be represented by blending together eight layers of splats. As a result, the acoustic characteristics of a surface formed from splats are distributed across the different layers of splats. Accurate adjustment of sound contacting a surface formed from splats therefore includes accounting for the acoustic characteristics of the different layers of splats forming that surface. Surfaces in a splat-generated 3D environment may be represented by different number of splat layers such that splat audio engine 100 does not know how many layers of splats the sound ray should penetrate before being reflected back into the 3D environment.

Splat audio engine 100 performs various preprocessing of the splats to optimize the splats for the real-time sound adjustment. In some embodiments, the preprocessing involves analyzing the positioning of the splats in order to identify the splats at a depth layer of a represented surface or object that the sound rays are able to penetrate to before they are reflected or deflected away from that represented surface or object. In some such embodiments, the preprocessing includes generating a plane at the depth layer that splat audio engine 100 may use to determine when to reflect or deflect the sound rays that contact any splat of the represented surface or object.

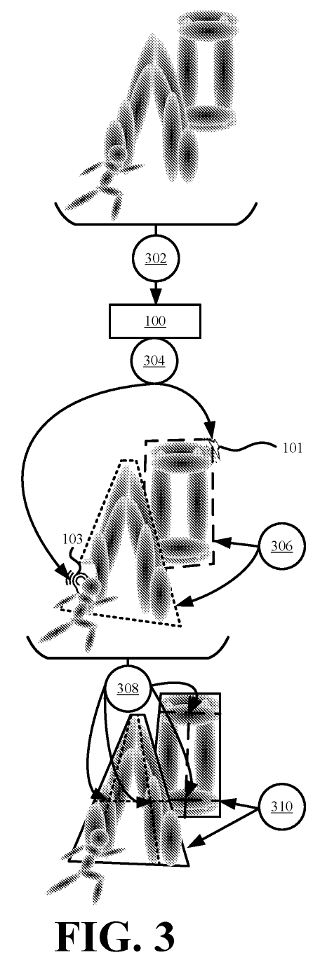

FIG. 3 illustrates an example of preprocessing splats for optimized real-time sound adjustment in accordance with some embodiments presented herein. Splat audio engine 100 receives (at 302) the splats that form a 3D environment or 3D model.

Splat audio engine 100 determines (at 304) positions of the splats relative to sound source 101 and listening position 103. For instance, the 3D environment may be a 3D game, 3D video, or 3D enhanced reality experience which places splats for different objects in between sound source 101 and listening position 103.

Splat audio engine 100 analyzes the splat positioning to detect (at 306) groups of splats that represent different surfaces or objects. Splats of a common surface may be positioned adjacent to one another in a pattern or within a threshold distance of one another. Splats of a common surface may also be identified by neighboring splats that have similar color values and/or color values that are within a threshold range of one another. In some embodiments, splat audio engine 100 may use a rendering engine to render the 3D environment and use artificial intelligence and/or machine learning techniques (AI/ML) to perform object recognition in the rendered 3D environment to detect (at 306) groups of splats that represent different surfaces or objects.

For each group of splats, splat audio engine 100 selects (at 308) a depth layer that sound rays projected from sound source 101 are able to penetrate to until they are reflected back into the 3D environment. The depth layer may correspond to a threshold number of splat layers. For surfaces or objects that are formed from less than the threshold number of splat layers, splat audio engine 100 selects (at 308) the splats at the lowest or furthest depth layer from sound source 101. As shown in FIG. 3, splat audio engine 100 selects (at 308) the depth layer to coincide to splats that are no more than three splat layers from sound source 101.

Selecting (at 308) the depth layer to not exceed the threshold number of splat layers ensures that the number of sound adjustments performed for any surface does not exceed a threshold number. For instance, a surface may be formed by splats in 8 different layers. Splat audio engine 100 may select (at 308) the splats in the fifth layer so that a sound ray contacting that surface is adjusted according to the acoustic characteristics of the splats in the first five layers and not splats in the deeper or lower layers.

Splat audio engine 100 defines (at 310) a tile at each selected depth layer. Defining (at 310) the tile may include generating a primitive that is not rendered and that approximates the shape of the surface or object, and placing the tile about the plane of the splats at the selected (at 308) depth layer.

When performing the sound adjustments, splat audio engine 100 may project the sound rays from sound source 101 and adjust the sound of the sound rays based on the acoustic characteristics of splats in the ray path until reaching a tile. Once the tile is reached, splat audio engine 100 reflects or deflects the sound ray back into the 3D environment according to the orientation of the splat at the same depth layer as the tile, a surface normal of the splat at the same depth layer as the tile, or a surface normal that is derived for the contacted surface based on the orientations or surface normals of the group of splats that form that surface.

In some embodiments, the depth at which a sound ray penetrates the splats and at which the sound ray is reflected back into the 3D environment may be based on the acoustic characteristics of the splats. The acoustic characteristics may be defined as part of the splat definition. For instance, each splat may be defined with parameters for echo, reflection, reverberation, attenuation, pitch adjustment, tone adjustment, and/or other sound effects that the splat imparts on sound that contacts that splat. Alternatively, the acoustic characteristics may be derived from existing attributes or parameters of the splats. For instance, the splat transparency and orientation relative to the sound ray may be used to derive the acoustic characteristics and/or how the splats reflect sound.

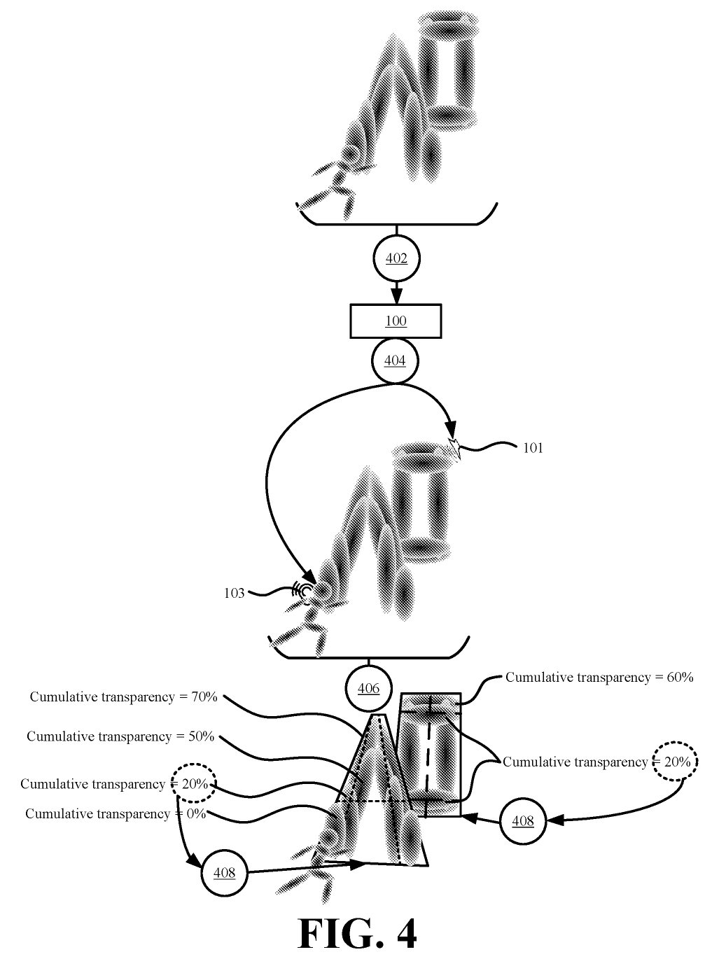

FIG. 4 illustrates an example of preprocessing the splats for optimized real-time sound adjustment based on existing attributes of the splats in accordance with some embodiments presented herein. Splat audio engine 100 receives (at 402) the splats that form a 3D environment or 3D model.

Splat audio engine 100 determines (at 404) positions of the splats relative to sound source 101 and listening position 103. In some embodiments, the listening position 103 corresponds to the position at which the splat-generated 3D environment is rendered.

Splat audio engine 100 computes (at 406) a cumulative transparency for selected splats at different depths based on the selected splat’s transparency and the transparency of other splats that are part of or form the same surface and that are positioned between the selected splat and sound source 101. For instance, splat audio engine 100 may add the transparency values of the selected splat and the intervening splats between the selected splat and sound source 101 to derive the cumulative transparency for the selected splat. Splat audio engine 100 halts the computation upon reaching a depth at which the cumulative transparency for the splats at that depth is equal to or greater than a transparency threshold. The transparency threshold may be a value that corresponds to a depth at which sound cannot penetrate past the splats and is reflected back into the 3D environment. For instance, a first splat with a cumulative transparency of 80% may allow the sound ray to penetrate past the first splat, whereas a second splat with a cumulative transparency of 10% or less may prevent the sound ray from further penetration and may reflect the sound ray back into the 3D environment based on a surface normal or orientation associated with the second splat.

In some embodiments, the cumulative transparency computation (at 406) is adjusted based on the orientation of the splats or a combination of the splat transparency and orientation. Splats with an orientation that is offset relative to the position of a sound source or a sound ray may affect less of the sound than splats with an orientation is perpendicular or flat relative to the position of the source or the sound ray.

Splat audio engine 100 defines (at 408) a tile at a plane or depth of splats where the cumulative transparency satisfies a transparency threshold. Once again, defining (at 408) the tile may include generating a primitive that is not rendered and that approximates the shape of the surface or object, and placing the tile about the plane of the splats that have a cumulative transparency that satisfies the transparency threshold. For surfaces or objects where the cumulative transparency of the splats forming those surfaces or objects does not satisfy the transparency threshold, splat audio engine 100 may define (at 408) a tile at the same plane as the splats that form those surfaces or objects at the lowest or further plane from sound source 101.

The number of splats defined in a 3D environment may be in the millions or billions. Accordingly, the preprocessing of individual splats may be computationally expensive. To simplify and/or optimize the preprocessing, splat audio engine 100 may define tiles to represent two or more splats and perform the preprocessing relative to the tiles rather than the individual splats.

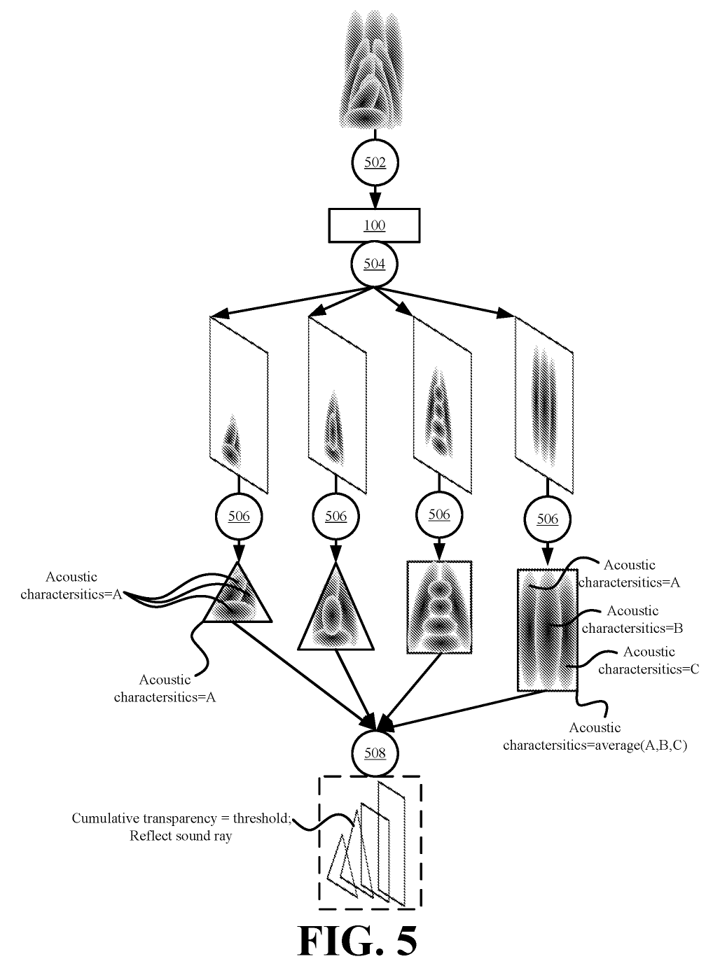

FIG. 5 illustrates an example of preprocessing or optimizing a splat-generated 3D environment for real-time sound adjustment using tiles in accordance with some embodiments presented herein. Splat audio engine 100 receives (at 502) the splats that form a 3D environment or 3D model.

Splat audio engine 100 selects (at 504) groups of splats that are about a common plane and that represent one layer of a common surface. For instance, splat audio engine 100 detects the splats that form a particular 3D object, and selects (at 504) each group of splats to include splats that have at least one common x, y, or z coordinate or that are oriented about a common plane.

Splat audio engine 100 defines (at 506) a tile to replace or represent each group of splats. The tile is defined (at 506) with a shape that spans or approximates the shape of the group of splats. The tile may be defined (at 506) as a simple 2D primitive (e.g., square, triangle, circle, etc.). The tile is defined (at 506) with attributes and/or properties of the group of splats. For instance, the tile may be defined (at 506) with a transparency value that is the average of the transparency values defined for group of splats. Similarly, the tile may be defined (at 506) with a surface normal based on the surface normals or orientation of the splats the tile represents.

In some embodiments, defining (at 506) the tiles includes associating the acoustic characteristics from the group of splats to the tile. In some such embodiments, splat audio engine 100 defines (at 506) a single set of acoustic characteristics for the tile based on different acoustic characteristics of the splats that are represented by the tile. Splat audio engine 100 may average the acoustic characteristics of the splats in order to define (at 506) the acoustic characteristics of the tile. Alternatively, splat audio engine 100 may derive the acoustic characteristics of the tile by weighting the acoustic characteristics of the splats differently based on their transparency, orientation, and/or percentage of the tile surface area occupied by a splat. For instance, the acoustic characteristics of a splat that is oriented away from the plane of the tile and that occupies 5% of the tile surface area are given less weight and contribute less to the acoustic characteristics of the tile than a splat that is oriented along the plane of the tile and that occupies 10% of the tile surface area.

Splat audio engine 100 may perform (at 508) the preprocessing relative to the tiles rather than the individual splats. The preprocessing may include identifying the tiles that represent the last surface layer that sound penetrates and/or the surface layer at which sound is reflected back into the 3D environment. The tiles may be used to determine when sound rays contact the represented 3D object or surface based on the position and/or surface area of the tiles rather than the positions and/or surface area of the individual splats, and may be used to calculate the adjustment to the contacting sound rays based on the acoustic characteristics of the tiles rather than the acoustic characteristics of individual splats.

Splat audio engine 100 may leverage the preprocessing output to perform the sound adjustment in real-time or in synchronization with the rendering of the splats and/or the sounds that are generated from the various sound sources for the rendered visualizations. The real-time sound adjustment includes generating audio for the splat-generated 3D environment that is adjusted according to the acoustic characteristics of the splats as the splat-generated 3D environment is rendered. The acoustic characteristics may model or represent different effects that materials, objects, or surfaces represented by the splats have on sound to impart a sense of realism for different environments and/or interactions of sound with the different environments. Accordingly, splat audio engine 100 may dynamically adjust sound in the splat-generated 3D environment in real-time based on the realistic and simulated interactions that the sound has with the different acoustic characteristics of the different materials, objects, or surfaces represented by the different splats in the sound path from a sound source to a listening position.

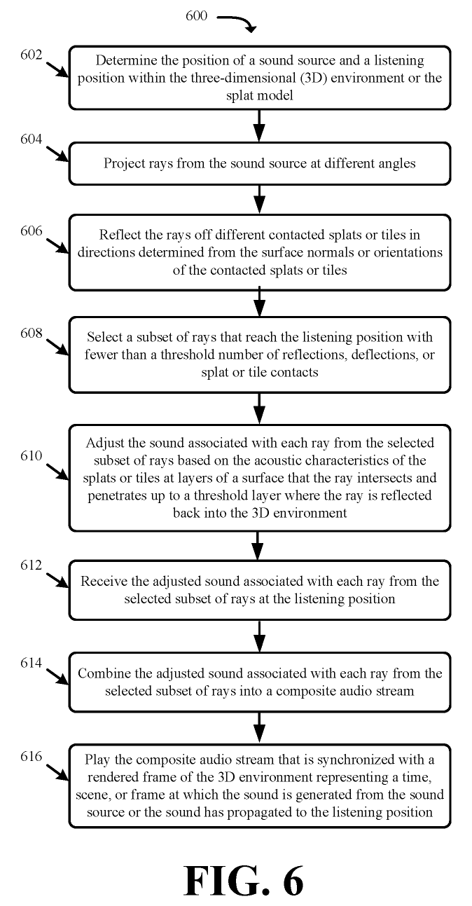

FIG. 6 presents a process 600 for performing the real-time sound adjustment in a splat-generated 3D environment in accordance with some embodiments presented herein. Process 600 is implemented by splat audio engine 100 as part of a 3D system that generates a visual 3D experience with realistic sound. Splat audio engine 100 or the 3D system that includes splat audio engine 100 may execute on one or more devices or machines with processing, memory, storage, network, and/or hardware resources to create the dynamic realistic adjusted sound for the 3D environment.

Process 600 includes determining (at 602) the position of a sound source and a listening position within the 3D environment or the splat model. The position of the sound source may be linked to a set of splats from which the sound is emitted. For instance, the set of splats may represent a character or an object that produces sound (e.g., a vehicle, a horn, an engine, etc.). In some embodiments, the sound source or the linked set of splats may be identified in metadata, as part of the splat model, or as other sound data that is included with the splat definition. In some embodiments, the listening position may correspond to the position at which the 3D environment is rendered. Accordingly, the render position or the position of a virtual camera within the 3D space of the 3D environment may be set as the listening position. In some other embodiments, the listening position is linked to another set of splats that represent a character or other object at which sound is heard or played back.

Process 600 includes projecting (at 604) rays from the sound source at different angles that span the full width of a sound wave being emitted from the sound source. The rays simulate the propagations of the sound wave as fixed linear elements rather than an expanding or continuous wave. In some embodiments, splat audio engine 100 may disregard the propagation of a sound wave in vertical directions and/or planes and may project (at 604) the rays as straight lines or vectors about a single vertical plane. The single vertical plane may correspond to the plane or height of the listening position.

Process 600 includes reflecting (at 606) the rays off different contacted splats or tiles in directions determined from the surface normals or orientations of the contacted splats or tiles. In particular, splat audio engine 100 projects (at 604) a ray from the sound source at a specified angle and determines when the ray intersects or contacts any part of a splat or tile in the 3D environment. In response to determining the ray intersection or contact, splat audio engine 100 reflects or deflects the ray in a new direction that is determined from the surface normal or orientation of the contacted splat or tile.

Process 600 includes selecting (at 608) a subset of rays that reach the listening position with fewer than a threshold number of reflections, deflections, or splat or tile contacts. Sound is attenuated each time it reflects off a surface. Accordingly, the threshold number of reflections, deflections, or splat or tile contacts may represent or estimate an aggregate amount of attenuation before the sound is inaudible or inconsequential to the sound played back at the listening position. Additionally, splat audio engine 100 may limit the number of rays in the subset of rays to a threshold number. Limiting the number of rays in the subset of rays may reduce or cap the total number of sound adjustments that are performed and/or restrict the number of adjusted sound samples for generating the final adjusted sound at the listening position. For instance, the adjusted sound from ten different rays projected into the splat-generated 3D environment at different angles may be sufficient to represent all or the majority of the sound effects that surfaces or materials in the 3D environment impart on the sound.

Process 600 includes adjusting (at 610) the sound associated with each ray from the selected (at 608) subset of rays based on the acoustic characteristics of the splats or tiles at layers of a surface that the ray intersects and penetrates up to a threshold layer where the ray is reflected back into the 3D environment. In some embodiments, the threshold layer may be identified by the definition of a tile or splats that are tagged with an identifier during the preprocessing phase. The threshold layer corresponds to a number of splat layers that the ray is allowed to penetrate and to be adjusted by and may be preconfigured to a set value to cap the number of calculations or sound adjustments that are performed. The threshold layer may also represent a layer or depth at which sound cannot penetrate and is reflected back. When a surface is represented with fewer than the threshold layer of splats, the splats at the lowest or last layer of the surface are tagged to prevent the contacting sound ray from penetrating past that lowest or last layer of splats and that lowest or last layer becomes the layer at which the ray is reflected back. In some embodiments, the threshold layer is dynamically determined based on the cumulative transparency and/or the orientation of the splats at the different layers of a surface. For instance, the ray may penetrate layers where the splats are offset or orientated at an angle relative to the sound and may be reflected back when contacting a splat that is flat or perpendicular relative to the ray. In some embodiments, the offset splats contribute to the cumulative transparency based on how much they are offset from the ray such that the ray is reflected back once the cumulative transparency reaches a threshold transparency or the last layer of splats is reached.

In some embodiments, the adjusting (at 610) of the sound includes splat audio engine 100 projecting each ray from the selected (at 608) subset of rays from the sound source a second time, detecting an intersection or point of contact between a first splat or a first tile in a first layer of a contacted surface, adjusting the sound associated with the ray based on the acoustic characteristics of the first splat or the first tile and any additional splats or tiles at additional lower layers of the contacted surface until reaching the splats or tiles that are tagged to indicate the threshold layer or final layer of the contacted surface at which the sound ray is reflected. The sound ray is reflected back into the 3D environment based on the surface normal or orientation of the splat or tile in the threshold layer or the final layer or a combination of all surface normals or orientations of the splats or tiles that the ray passed through.

Process 600 includes receiving (at 612) the adjusted sound associated with each ray from the selected (at 608) subset of rays at the listening position. The subset of rays are received (at 612) at the listening position when the rays are reflected and/or projected in the direction of the listening position. It should be noted that receiving (at 612) the adjusted sound at the listening position does not require that the rays intersect or contact the listening position. Rather, the rays may be received (at 612) at the listening position when the rays pass near or around the listening position as the rays are meant to represent a sound wave.

Process 600 includes combining (at 614) the adjusted sound associated with each ray from the selected (at 608) subset of rays into a composite audio stream. In some embodiments, the adjusted sound from each ray may contribute equally or disproportionately to the composite audio stream. For instance, the attenuation from a first sound ray may be combined (at 614) with the reverberation from a second sound ray to generate the composite audio stream in response to a greater attenuation of the first sound ray and a greater amount of reverberation added to the second ray than other rays of the subset of rays. In some other embodiments, the adjusted sound from the subset of rays is averaged together or combined equally to generate the composite audio stream.

Process 600 includes playing (at 616) the composite audio stream that is synchronized with a rendered frame of the 3D environment representing a time, scene, or frame at which the sound is generated from the sound source or the sound has propagated to the listening position. For instance, different sounds may be generated from the sound source in response to changes in the 3D environment. Splat audio engine 100 may play (at 616) the composite audio stream with the adjustments to the different sounds when the frames that visually represent the changes in the 3D environment are rendered and presented.

In an animated or dynamic 3D environment, the position of the sound source or the listening position may change in different rendered frames of the 3D environment. Process 600 causes splat audio engine 100 to dynamically adjust the sound based on the acoustic characteristics of the different splats or tiles that the sound rays contact from the different sound source and/or listening positioning positions and synchronizes the playback (at 616) of the adjusted sound for the different positions with the playback of the rendered frames for those different positions.

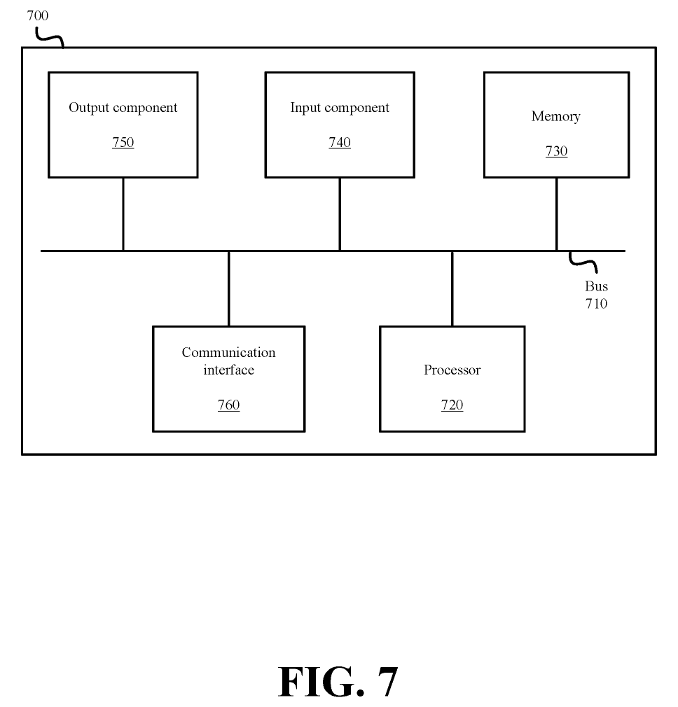

FIG. 7 is a diagram of example components of device 700. Device 700 may be used to implement one or more of the tools, devices, or systems described above (e.g., splat audio engine 100, rendering engine, 3D system, etc.). Device 700 may include bus 710, processor 720, memory 730, input component 740, output component 750, and communication interface 760. In another implementation, device 700 may include additional, fewer, different, or differently arranged components.

Bus 710 may include one or more communication paths that permit communication among the components of device 700. Processor 720 may include a processor, microprocessor, or processing logic that may interpret and execute instructions. Memory 730 may include any type of dynamic storage device that may store information and instructions for execution by processor 720, and/or any type of non-volatile storage device that may store information for use by processor 720.

Input component 740 may include a mechanism that permits an operator to input information to device 700, such as a keyboard, a keypad, a button, a switch, etc. Output component 750 may include a mechanism that outputs information to the operator, such as a display, a speaker, one or more LEDs, etc.

Communication interface 760 may include any transceiver-like mechanism that enables device 700 to communicate with other devices and/or systems. For example, communication interface 760 may include an Ethernet interface, an optical interface, a coaxial interface, or the like. Communication interface 760 may include a wireless communication device, such as an infrared (IR) receiver, a Bluetooth^{®} radio, or the like. The wireless communication device may be coupled to an external device, such as a remote control, a wireless keyboard, a mobile telephone, etc. In some embodiments, device 700 may include more than one communication interface 760. For instance, device 700 may include an optical interface and an Ethernet interface.

Device 700 may perform certain operations relating to one or more processes described above. Device 700 may perform these operations in response to processor 720 executing software instructions stored in a computer-readable medium, such as memory 730. A computer-readable medium may be defined as a non-transitory memory device. A memory device may include space within a single physical memory device or spread across multiple physical memory devices. The software instructions may be read into memory 730 from another computer-readable medium or from another device. The software instructions stored in memory 730 may cause processor 720 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

The actual software code or specialized control hardware used to implement an embodiment is not limiting of the embodiment. Thus, the operation and behavior of the embodiment has been described without reference to the specific software code, it being understood that software and control hardware may be designed based on the description herein.

For example, while series of messages, blocks, and/or signals have been described with regard to some of the above figures, the order of the messages, blocks, and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, while some devices are shown as communicating with a network, some such devices may be incorporated, in whole or in part, as a part of the network.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well-known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Some implementations described herein may be described in conjunction with thresholds. The term “greater than” (or similar terms), as used herein to describe a relationship of a value to a threshold, may be used interchangeably with the term “greater than or equal to” (or similar terms). Similarly, the term “less than” (or similar terms), as used herein to describe a relationship of a value to a threshold, may be used interchangeably with the term “less than or equal to” (or similar terms). As used herein, “exceeding” a threshold (or similar terms) may be used interchangeably with “being greater than a threshold,” “being greater than or equal to a threshold,” “being less than a threshold,” “being less than or equal to a threshold,” or other similar terms, depending on the context in which the threshold is used.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

1. A method comprising:
projecting a plurality of sound rays at a plurality of angles from a sound source placed in a three-dimensional (3D) environment that is defined with a plurality of splats;
tracking different paths of the plurality of sound rays in the 3D environment, wherein tracking the different paths comprises adjusting the different paths at points in the 3D environment where the plurality of sound rays contact and reflect off different surfaces formed from different sets of the plurality of splats;
selecting a subset of sound rays from the plurality of sound rays that reach a listening position in the 3D environment with a threshold number of reflections;
adjusting sound associated with each particular sound ray of the subset of sound rays based on acoustic characteristics of splats that are layered over one another at a threshold number of layers of a different surface that the particular sound ray contacts and reflects off; and
playing a modified sound that is modified from an original sound emitted from the sound source based on said adjusting of the sound associated with each sound ray of the subset of sound rays.

2. The method of claim 1, wherein selecting the subset of sound rays comprises:
discarding sound rays that do not reach the listening position or that do not reflect towards or past the listening position within the threshold number of reflections.

3. The method of claim 1, wherein adjusting the different paths comprises:
reflecting a sound ray in response to the sound ray intersecting a position of a first splat from the different set of splats forming a surface from the different surfaces.

4. The method of claim 1, wherein adjusting the different paths comprises:
reflecting a sound ray according to a surface normal or orientation of one or more splats that form a surface that is contacted by that sound ray.

5. The method of claim 1, wherein the acoustic characteristics of a particular splat comprise a sound adjustment that the particular splat imparts to the sound of a contacting sound ray that contacts the particular splat.

6. The method of claim 5, wherein the sound adjustment comprises one or more of:
an amount of attenuation, reverberation, or echo that the particular splat imparts to the sound of the contacting sound ray.

7. The method of claim 5 further comprising:
determining the acoustic characteristics of the particular splat based on a one or more of a transparency or an orientation of the particular splat.

8. The method of claim 1 further comprising:
setting the threshold number of layers at a particular layer of a particular surface in response to a cumulative transparency of splats between a first layer and the particular layer satisfying a threshold transparency.

9. The method of claim 1 further comprising:
preprocessing the plurality of splats prior to rendering the 3D environment.

10. The method of claim 9, wherein preprocessing comprises said tracking of the different paths and said selecting of the subset of sound rays.

11. The method of claim 9, wherein preprocessing comprises:
determining the threshold number of layers at which the plurality of sound rays penetrate each particular surface of the different surfaces based on one or more of a transparency or an orientation of the different set of splats that form that particular surface.

12. A system comprising:
a audio engine that executes on one or more hardware processors and that performs operations comprising:
projecting a plurality of sound rays at a plurality of angles from a sound source placed in a three-dimensional (3D) environment that is defined with a plurality of splats;
tracking different paths of the plurality of sound rays in the 3D environment, wherein tracking the different paths comprises adjusting the different paths at points in the 3D environment where the plurality of sound rays contact and reflect off different surfaces formed from different sets of the plurality of splats;
selecting a subset of sound rays from the plurality of sound rays that reach a listening position in the 3D environment with a threshold number of reflections;
adjusting sound associated with each particular sound ray of the subset of sound rays based on acoustic characteristics of splats that are layered over one another at a threshold number of layers of a different surface that the particular sound ray contacts and reflects off; and
playing a modified sound that is modified from an original sound emitted from the sound source based on said adjusting of the sound associated with each sound ray of the subset of sound rays.

13. The system of claim 12, wherein selecting the subset of sound rays comprises:
discarding sound rays that do not reach the listening position or that do not reflect towards or past the listening position within the threshold number of reflections.

14. The system of claim 12, wherein adjusting the different paths comprises:
reflecting a sound ray in response to the sound ray intersecting a position of a first splat from the different set of splats forming a surface from the different surfaces.

15. The system of claim 12, wherein adjusting the different paths comprises:
reflecting a sound ray according to a surface normal or orientation of one or more splats that form a surface that is contacted by that sound ray.

16. The system of claim 12, wherein the acoustic characteristics of a particular splat comprise a sound adjustment that the particular splat imparts to the sound of a contacting sound ray that contacts the particular splat.

17. The system of claim 16, wherein the sound adjustment comprises one or more of:
an amount of attenuation, reverberation, or echo that the particular splat imparts to the sound of the contacting sound ray.

18. The system of claim 16, wherein the audio engine further performs operations comprising:
determining the acoustic characteristics of the particular splat based on a one or more of a transparency or an orientation of the particular splat.

19. The system of claim 12, wherein the audio engine further performs operations comprising:
setting the threshold number of layers at a particular layer of a particular surface in response to a cumulative transparency of splats between a first layer and the particular layer satisfying a threshold transparency.

20. A non-transitory computer-readable medium storing instructions that, when executed by one or more processors of a system comprising a audio engine, cause the audio engine to perform operations comprising:
projecting a plurality of sound rays at a plurality of angles from a sound source placed in a three-dimensional (3D) environment that is defined with a plurality of splats;
tracking different paths of the plurality of sound rays in the 3D environment, wherein tracking the different paths comprises adjusting the different paths at points in the 3D environment where the plurality of sound rays contact and reflect off different surfaces formed from different sets of the plurality of splats;
selecting a subset of sound rays from the plurality of sound rays that reach a listening position in the 3D environment with a threshold number of reflections;
adjusting sound associated with each particular sound ray of the subset of sound rays based on acoustic characteristics of splats that are layered over one another at a threshold number of layers of a different surface that the particular sound ray contacts and reflects off; and
playing a modified sound that is modified from an original sound emitted from the sound source based on said adjusting of the sound associated with each sound ray of the subset of sound rays.
